(19) United States
(12) Patent Application Publication
(10) Pub. No.: US 2003/0229811 A1
(43) Pub. Date: Dec. 11, 2003

(54) Method that provides multi-tiered authorization and identification

(75) Inventors: William G. Siegel, Wellington, FL (US); Gregory L. Cannon, Boynton Beach, FL (US); Thomas Buss, Jupiter, FL (US); George W. McClurg, Jensen Beach, FL (US); Mark Southwick, Lake Worth, FL (US); Richard Irving, Palm Beach Gardens, FL (US); Ron Kropp, West Palm Beach, FL (US); John Vandusen, Jupiter, FL (US); Trent Francis, Hobe Sound, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/283,361

(22) Filed: Oct. 30, 2002

Related U.S. Application Data
(60) Provisional application No. 60/330,794, filed on Oct. 31, 2001.

(51) Int. Cl. H04L 9/32

(52) U.S. Cl. 713/202

(57) ABSTRACT

A system and method are used to perform multi-tired authorization to enhance security during transactions. Data (e.g., biometric, print, universally unique identifier (UUID), financial, and/or other types of data) of a first entity (e.g., a consumer or the like) is captured using a wireless transceiver biometric device. The captured data is verified against previously stored data. Results from the verification are transmitted to second and third entities (e.g., insurance and financial entities, government and private entities, first and second government entities, law enforcement and administrative agency entities, or the like pairs). Data (e.g., similar to that discussed above) of a fourth entity (e.g., a retail or wholesale product or service entity) is captured using the same or another wireless transceiver biometric device. The captured data is verified against previously stored data. Results from the verification are sent to the second and third entities (e.g., similar to the entity pairs discussed above). A transaction between the first and fourth entities is controlled based on the results. Using thus system an method, all parties can be assured of identity, authority, and legitimacy of all other parties to the transaction.

### RELATED APPLICATIONS

This application claims priority under 35 U.S.C. §119(e) to U.S. Provisional Application Ser. No. 60/330,794, filed Oct. 31, 2001, which is incorporated herein by reference in its entirety.

### FIELD OF THE INVENTION

The present invention relates generally to a piezoelectric identification device and applications thereof. More particularly, it relates to a device for obtaining biometric information, such as a print, and using the obtained information to recognize and/or identify an individual.

### BACKGROUND OF THE INVENTION

Biometrics are a group of technologies that provide a high level of security. Print capture and recognition is an important biometric technology. Law enforcement, banking, voting, and other industries increasingly rely upon prints as a biometric to recognize or verify identity. See, Biometrics Explained, v. 2.0, G. Roethenbaugh, International Computer Society Assn. Carlisle, Pa. 1998, pages 1-34 (incorporated herein by reference in its entirety). Generally, a biometric is a measurable, physical characteristic or personal behavior trait used to recognize the identity, or verify the claimed identity, of a person who has a biometric reference template (e.g., data that represents a biometric measurement) on file.

Optical print scanners are available which detect a reflected optical image of a print. To capture a quality image at a sufficiently high resolution, optical print scanners require at minimum optical components (e.g., lenses), an illumination source, and an imaging camera. Such components add to the overall cost of a print scanner. Mechanical structures to maintain alignment also increase manufacturing and maintenance costs.

Solid-state silicon-based transducers are also available in print scanners sold commercially. Such silicon transducers measure capacitance. This requires the brittle silicon transducers to be within a few microns of the print sensing circuit reducing their durability. To detect a rolled print, the sensing array of the solid-state transducer needs to have an area of 1 inch×1 inch and a thickness of about 50 microns. This is a big geometry for silicon that increases the base cost of a print scanner and leads to greater maintenance costs. Durability and structural integrity are also more likely to suffer in such a large silicon geometry.

In today's society, consumers always want assurances the products or services they purchase will perform satisfactorily. They do this by either insuring the transaction or purchasing warranties or service agreement for the transaction. This often requires a laborious process that becomes burdensome when it is required for each purchase or service. This deters people from pursuing some products or services. Also, more often people are skeptical about the other party they are dealing with. This also deters interactions and transactions from occurring. The hesitation is based on not knowing whether a representative of a party is authorized to make a transaction and/or whether the part is a legitimate business concern.

What is needed is an inexpensive, durable print scanner with low maintenance costs. What is also needed is a system and method that allows for simultaneous insuring or underwriting of some sort for purchased products and services. What is also need is a system and method that allows for simultaneous or subsequent identity authentication before a transactions can take place, which ensures both authority of transaction and legitimacy of parties.

### BRIEF SUMMARY OF THE INVENTION

Embodiments of the present invention provide a method including the steps of capturing data of a first entity using a first wireless transceiver biometric device, verifying the captured data of the first entity to previously stored data, and transmitting results of the verifying step to a second entity and a third entity. The method also includes the steps of capturing data from a fourth entity using a second wireless transceiver biometric device, verifying the captured data of the fourth entity to previously stored data, and transmitting results of the verifying step to the second entity and the third entity. The method further including the step of controlling a transaction based on the transmitting results steps.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a wireless transceiver biometric device according to an embodiment of the invention.

FIG. 2 illustrates a more detailed view of the wireless transceiver biometric device of FIG. 1.

FIG. 3 illustrates a piezoelectric identification device according to an embodiment of the invention.

FIG. 4 illustrates circuit components of an identification device according to an embodiment of the invention.

FIG. 5 illustrates a wireless transceiver biometric device according to an embodiment of the invention.

FIG. 6 illustrates example environments in which the wireless transceiver biometric device of FIG. 1 can be used to complete different types of transactions.

FIG. 7 is a diagram illustrating an exemplary transaction between a consumer and a provider using a multi-tiered transaction according to an embodiment of the present invention.

FIG. 8 is a flowchart depicting a method according to embodiments of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

I. Overview of the Invention

Embodiments of the present invention provide a system and method for performing multi-tired authorization to enhance security during transactions. Data (e.g., biometric, print, universally unique identifier (UUID), financial, and/or other types of data) of a first entity (e.g., a consumer or the like) is captured (e.g., sensed, detected, stored, etc.) using a wireless transceiver biometric device. The captured data is verified against previously stored data. Results (e.g., scores from matching, described in more detail below) from the verification are transmitted to second and third entities (e.g., insurance and financial entities, government and private entities, first and second government entities, law enforcement and administrative agency entities, or the like pairs). Data (e.g., similar to that discussed above) of a fourth entity (e.g., a retail or wholesale product or service entity) is captured using the same or another wireless transceiver biometric device. The captured data is verified against previously stored data. Results from the verification are sent to the second and third entities (e.g., similar to the entity pairs discussed above). A transaction between the first and fourth entities is controlled based on the results. Using thus system an method, all parties can be assured of identity, authority, and legitimacy of all other parties to the transaction.

The present invention relates generally to a piezoelectric identification device and applications thereof. More particularly, it relates to a piezoelectric device for obtaining biometric data or information, such as for a print, and using the obtained information to recognize and/or verify the identify of an individual. Print can be any type of print including, but not limited to, a print of all or part of one or more fingers, palms, toes, foot, hand, etc. A print can also be a rolled print, a flat print, or a slap print. The use of the term “data” or “information” throughout the specification can be representative of a biometric, a digital or other image of a biometric (e.g., a bitmap or other file), extracted digital or other information relating to the biometric, etc.

The use of the term “match” or “matching” can be defined as the process of comparing a biometric sample against a previously stored template and scoring the level of similarity. Then, an accept or reject decision can be made based upon whether this score exceeds a predetermined threshold. Matching can be performed by comparing a party's print to one or more stored prints to either (1) determine if there is a match against the party's alleged identity or (2) a match against any stored print when there is no alleged identity.

The use of the term “verify” or “verification” can be defined as a one-to-one process of comparing a submitted biometric sample against a biometric reference or template (e.g., data which represents a biometric measurement of an enrollee, used by a biometric system for comparison against subsequently submitted biometric samples) of a single enrollee whose identity is being claimed to determine whether the submitted biometric sample matches the enrollee's template.

The use of the term “identify” or “identification” can be defined as the one-to-many process of comparing a submitted biometric sample against all of the biometric reference templates on file to determine whether it matches any of the templates and, if so, the identity of the enrollee who template was matched.

II. Wireless Transceiver Biometric Devices

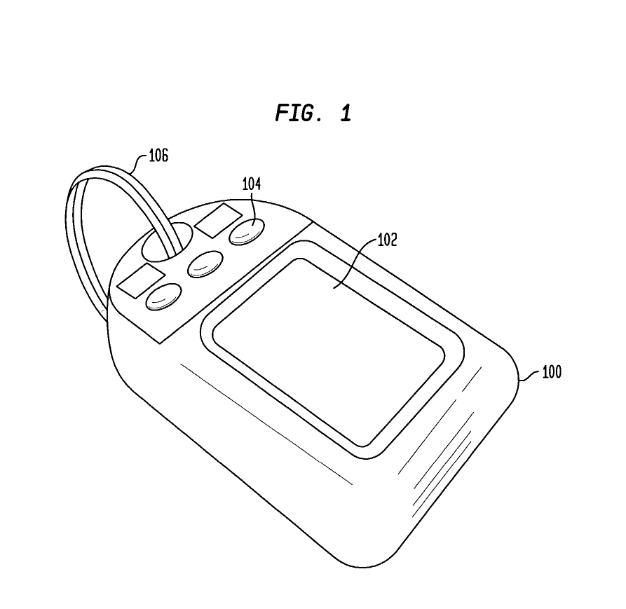

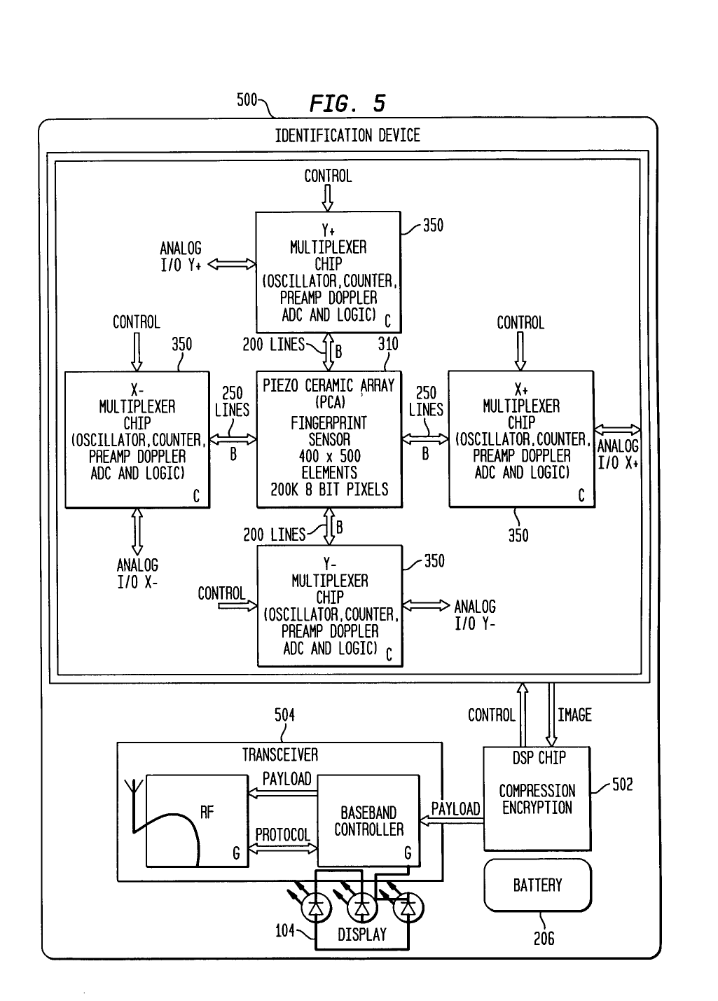

FIG. 1 illustrates a wireless transceiver biometric device 100 according to embodiments of the present invention. Device 100 is intended to be used by the general populace, for example, as an electronic signature device. Device 100 has a sensor 102 for obtaining biometric data (e.g., print data). In some embodiments, sensor 102 can be a piezo ceramic sensor or piezo electric thin film sensor. Device 100 can also have three indicator lights 104 for communicating information to a user. A key ring 106 can be attached to device 100. In same embodiments wireless transceiver biometric device 100 includes a BLUETOOTH wireless transceiver biometric device, as described further below with respect to FIG. 5.

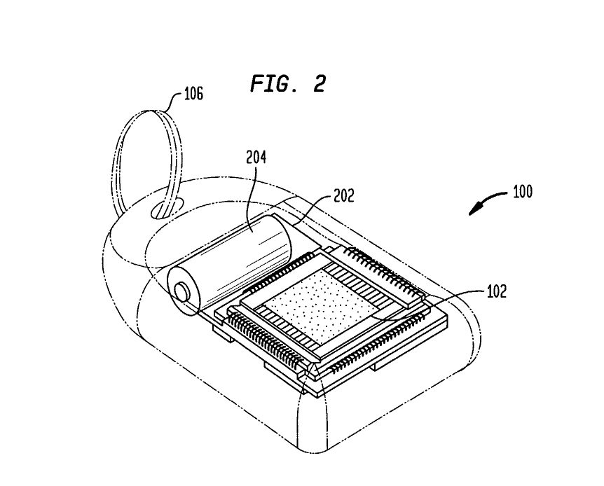

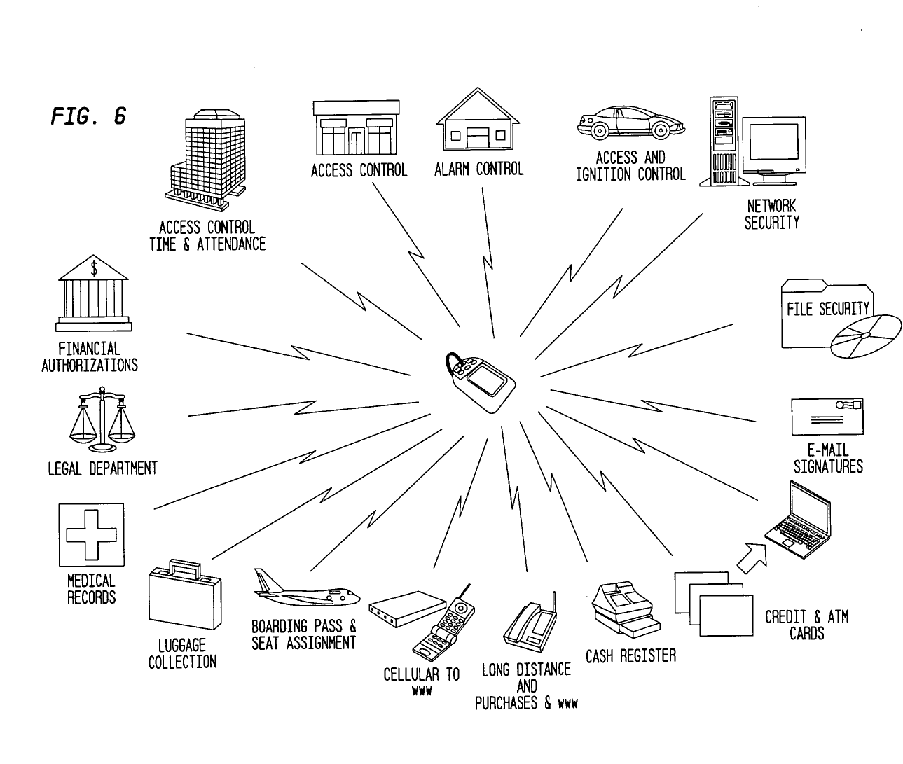

FIG. 2 illustrates a more detailed view of wireless transceiver biometric device 100 according to embodiments of the present invention. Device 100 has an antenna 202 that can be used for sending information to and receiving information from other devices. Sensor 102 is powered by a battery 204. In some embodiments, device 100 can be made to be compatible with BLUETOOTH wireless technology, as discussed above. Various uses of device 100 are described below in reference to FIGS. 6-8.

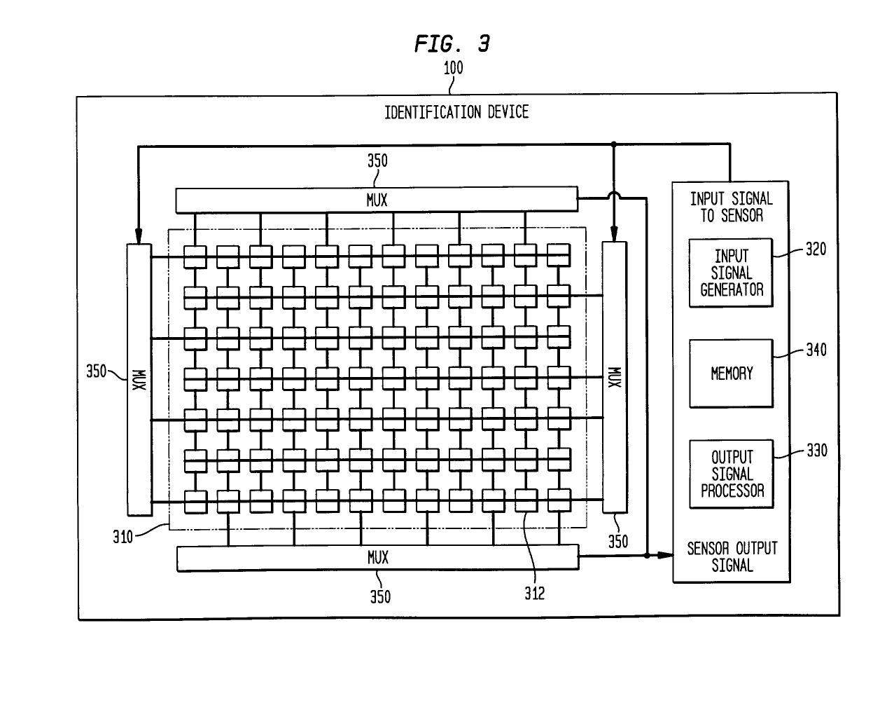

FIG. 3 is a schematic diagram of wireless transceiver biometric device 100 according to embodiments of the present invention. Identification device 100 has a piezoelectric sensor 310, a sensor input signal generator 320, a sensor output signal processor 330, and a memory 340. The input signal generated by input signal generator 320 is coupled to sensor 310 by two multiplexers 350. The output signal of sensor 310 is similarly coupled to output signal processor 330 by two multiplexers 350. In some embodiments, sensor 310 can be an array of piezo ceramic elements. In some embodiments, sensor 310 can include an array of polycrystalline ceramic elements that are chemically inert and immune to moisture and other atmospheric conditions. Polycrystalline ceramics can be manufactured to have specific desired physical, chemical, and/or piezoelectric characteristics. In other embodiments, sensor 310 can include a piezoelectric film (e.g., a polarized fluoropolymer film, such as polyvinylidene fluoride (PVDF) film or its copolymers can be used).

More detailed information on the elements and functions of the wireless transceiver biometric device can be found in the No. 60/330,794 Prov. App, which is incorporated by reference herein in its entirety.

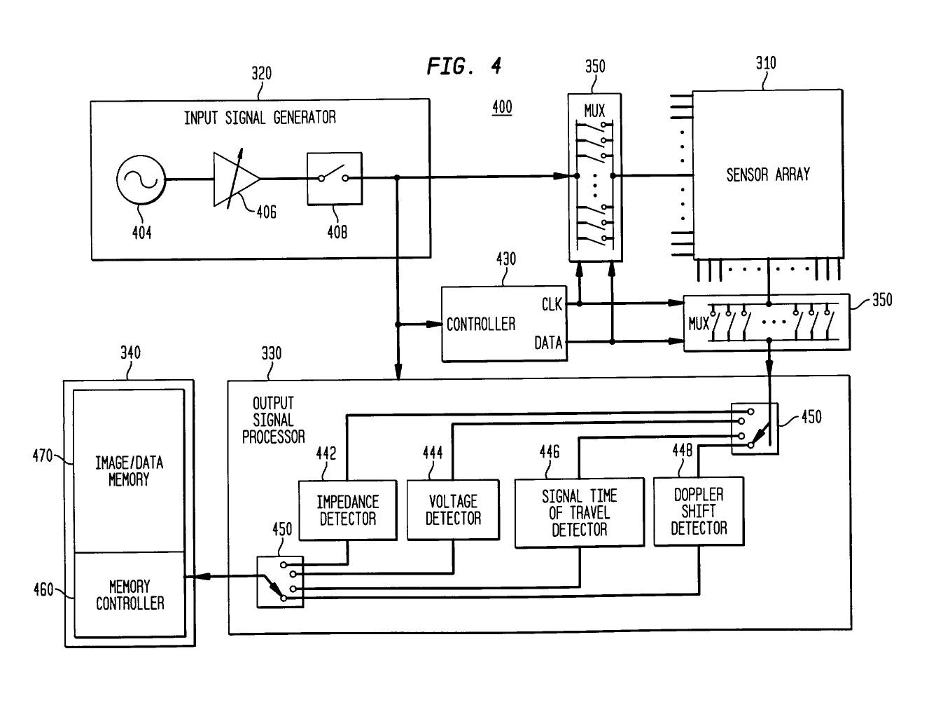

FIG. 4 illustrates an identification device 400 according to embodiments of the present invention. Device 400 includes an input signal generator 320, a sensor array 310, an output signal processor 330, a memory controller 460, and a memory 470. Sensor array 310 is coupled to input signal generator 320 and output signal processor 330 by multiplexers 350. A controller 430 controls the operation of multiplexers 350. The operation of identification device 400 is further described below.

In some embodiments, input signal generator 320 includes an input signal generator or oscillator 404, an variable amplifier 406, and a switch 408. In an embodiment, oscillator 404 produces a 20 MHz signal, which is amplified to either a low or a high voltage (e.g., about 4 volts or 8 volts) by variable amplifier 406, depending on the mode in which device 400 is operating. Switch 408 is used to provide either no input signal, a pulsed input signal, or a continuous wave input signal. Switch 408 is controlled to produce the various types of input signals described herein in a manner that would be known to a person skilled in the relevant art. The input signal generated by input signal generator 320 is provided to sensor array 310 via multiplexer 350, to controller 430, and to output signal processor 330. In an embodiment, sensor array 310 is a piezo ceramic composite of rectangular elements designed to operate with a 20 MHz input signal.

The output signal processor 330 includes various biometric detection devices, including an impedance detector 442, a voltage detector 444, a signal time of travel detector 446, and a doppler shift detector 448. Only one detector 442, 444, 446, or 448 is usually functioning during a period of time. Thus, switches 450 are used to coupled the functioning detector 442, 444, 446, or 448 to memory 340 and multiplexer 350. Further description of the operation of these detectors is found in U.S. Prov. App. No. 60/330,794, which is incorporated by reference herein in its entirety.

III. Example Applications

A. Overview of Applications

In some embodiments, one wireless transceiver biometric device 100 or 400 (e.g., BLUETOOTH device 500 with a piezo ceramic sensor as discussed below) can wirelessly communicate to different types of devices (e.g., computer mice, physical access control units, telephones, palm devices, set top boxes, computers, ATM machines, keyboards, locks, ignitions, etc.) to provide additional biometric-based security so that only an authorized person can operate the respective devices or gain a desired access or authorization. For example, wireless transceiver biometric device 100 or 400 (e.g., BLUETOOTH device 500 with a piezo ceramic sensor) can communicate over a piconet to a telephone to provide additional security so that only an authorized person can be operate the telephone. Similarly, wireless transceiver biometric device 100 or 400 can communicate to a remote control device to enhance security relating to the authorized use of set top boxes, televisions, recorders, players or other devices.

In other embodiments, a wireless transceiver biometric device 100 or 400 (e.g., BLUETOOTH device 500 with a piezo ceramic sensor) can be incorporated into any type of device where additional biometric security is desired. For example, wireless transceiver biometric device 100 or 400 can be incorporated in a telephone (not shown) to provide additional security so that only an authorized person can be operate the telephone. Similarly, wireless transceiver biometric device 100 or 400 can be built in a remote control device (not shown) to enhance security relating to the authorized use of set top boxes, televisions, recorders, players, or other devices.

In still other embodiments, device 100 or 400 can be used for: building access control; law enforcement; electronic commerce; financial transaction security; tracking employee time and attendance; controlling access to legal, personnel, and/or medical records; transportation security; e-mail signatures; controlling use of credit cards and ATM cards; file security; computer network security; alarm control; and identification, recognition, and verification of individuals.

In still other embodiments, wireless transceiver biometric device 100 or 400 is a low-cost, ubiquitous device that identifies a person and records the signature through both the print image and biological features such as blood flow. Information is transmitted to the other person(s) engaged in a transaction via a BLUETOOTH wireless network with other devices in the BLUETOOTH networks, such as a controller, a processor or computer (e.g., palm device, PDA, laptop, desktop, server, etc.), a set top box, a cellular telephone, a land-line telephone, and/or a vehicle (e.g., an automobile). Wireless transceiver biometric device 100 or 400 transmits authorization functions for physical access and alarm control, ignition control, computer and network access control, e-mail signatures, credit card transactions, cell phone identification, airline transactions, financial enrollment transactions, etc. via BLUETOOTH piconets.

In still other embodiments, wireless transceiver biometric device 100 or 400 can include a piezo ceramic sensor used for applications within many market segments including, but not limited to, financial, physical access control, automotive, telecommunications, computers, law and order, health care, immigration, and welfare markets. For example, in one financial market segment application, wireless transceiver biometric device 100 or 400 is used for physical access control for bank employees, cardholder verification and secure transaction certification. As another example, in one physical access control market segment application, wireless transceiver biometric device 100 or 400 can be used for automotive access and theft control, garage door, house access and activation of domestic security systems. As a still further example, in one automotive market segment application, wireless transceiver biometric device 100 or 400 can be used as an access and ignition control device. As a still further example, in one computer market segment application, wireless transceiver biometric device 100 or 400 can interact in a biometric device for network access control.

In still other embodiments, in one telecommunications market segment application, wireless transceiver biometric device 100 or 400 can be incorporated in a telephone. A wireless telephone or land-line telephone incorporates at least a sensor array, such as, a piezo ceramic sensor array or piezo electric thin film sensor array according to embodiments of the present invention. Communication and digital signal processor (DSP) functions can be carried out by the other components in the telephone. In other embodiments, BLUETOOTH is incorporated into both cellular and fixed station telephones for proximal communications. The telephone is then a flexible portal that the consumer will use to assert biometric authorizations and/or identifications according embodiments of the present invention.

These are just a few of the many useful applications of device 100 or 400 in particular, and the present invention in general. Additional applications for device 100 or 400 and the invention will be apparent to those skilled in the relevant arts given the description of the invention herein.

B. Personal Area Network Applications

FIG. 5 illustrates a wireless transceiver biometric device 500 according to embodiments of the present invention. As described herein, embodiments of the invention are capable of interacting with other devices as part of a personal area network. Device 500 includes a biometric device (labeled as an identification device), which is similar to device 400, and which includes a DSP chip 502, a BLUETOOTH chip 504, a display (which can be similar to 104), and a battery 206. The identification device can have a piezo ceramic sensor array 310 and four multiplexers 350, according to embodiments of the invention. The identification device is coupled to DSP 502. DSP 502 controls the identification device and stores biometric data. DSP 502 is also coupled to BLUETOOTH chip 504 for sending and receiving data. The display is used to communicate information to a user of device 500. Device 500 is powered by battery 206.

As would be known to a person skilled in the relevant art, BLUETOOTH is an agreement that governs the protocols and hardware for a short-range wireless communications technology. The invention is not limited to implementing only the BLUETOOTH technology. Other wireless protocols and hardware can also be used.

With continuing reference to FIG. 5, device 500 allows an individual to be in communication with compatible devices within about 30 feet of device 500. Device 500 can connect, for example, with telephones, cell phones, personal computers, printers, gas pumps, cash registers, Automated teller machines, door locks, automobiles, set top boxes, etc (none shown). Device 500 is able to supply a standardized secure identification or authorization token to any device, or for any process or transaction that needs or requests it. This is because device 500 can connect to and exchange information or data with any compatible device within a personal area network or piconet.

C. Electronic Sales and/or Transaction Applications

FIG. 6 illustrates using the wireless transceiver biometric device (e.g., device 100, 400, and/or 500) to provide security and/or to complete various transactions, according to embodiments of the present invention. The transactions shown, which are not exhaustive, include: alarm control, access and ignition control of a vehicle, network security, file security, e-mail signatures, credit and ATM cards, a cash register, long distance and www purchases, cellular, boarding pass and seat assignments, luggage collection, medical records, legal records, finical records, time and attendance records, access control, or the like.

D. Multi-tiered Authorization and Identification Applications

In an embodiment of the invention, multi-tiered transactions may occur. Multi-tiered transactions may provide additional services, such as, for example, insurance on the transaction. Multi-tiered transactions may also provide an additional levels of security. Although this is described using an insurance service as the additional tier, the invention is not limited to insurance services. Other types of services could be used without departing from the scope of the invention.

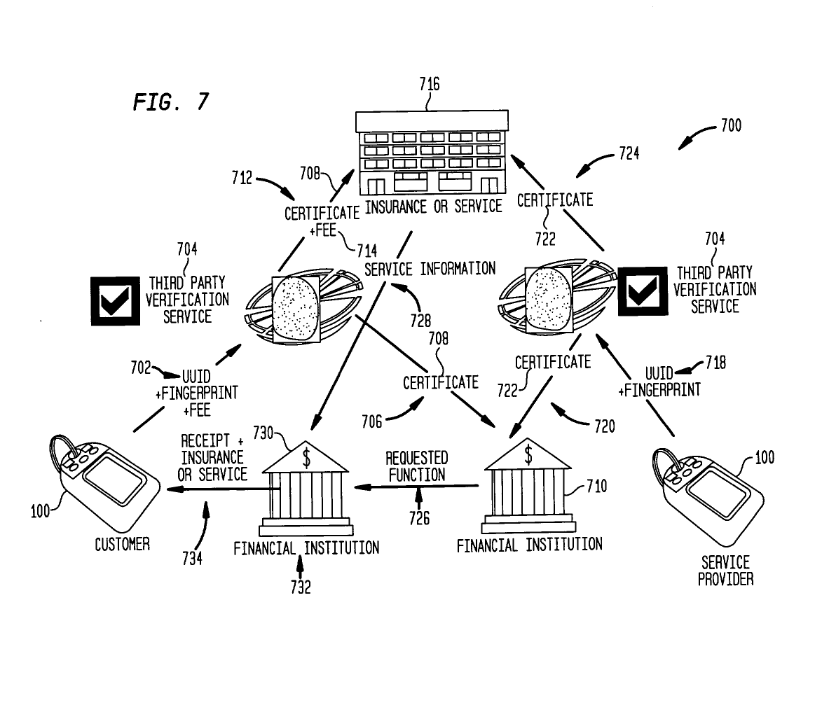

FIG. 7 is a diagram illustrating an multi-tiered transaction operation 700 between a consumer and a provider according to an embodiment of the present invention. In step 702, the customer submits a universally unique identifier (UUID) (e.g., a unique 128 bit long identifier that is unique across a combination of time and space fields), a print, and a fee into his/her wireless transceiver biometric device 100. This information is transmitted to third party verification service 704. The fee would be a money transfer that is uploaded for purchase of the service. Third party verification service 704 receives the print, UUID, and fee and uses the received print to verify the identity of the customer by matching the received print to print data stored in a database. In step 706, information related to the customer's identity and the customer's legitimacy to perform the transaction is transmitted from third party verification service 704 in the form of a certificate of authentication 708 to a financial institution 710. In step 712, third party verification service 704 sends certificate 708 and a fee 714, to an insurance service or some other service provider 716 that monitors the transaction.

In step 718, the service provider submits a UUID and print to third party verification service 704 using the service provider's wireless transceiver biometric device 100. Third party verification service 704 receives the print and UUID and uses the received print to verify the identity of the service provider by matching the received print to print data stored in a database. In step 720, information related to the service provider's identity and legitimacy to perform the transaction is transmitted from the third party verification service 704 in the form of a certificate of authentication 722 to financial institution 710. In step 724, the certificate 722 is sent by third party verification service 704 to service 716 that monitors the transaction.

In step 726, if both parties meet the required qualifications, the transaction is in a position to move forward. In step 728, service 716, after reviewing the qualifications of both parties, transmits to financial institution insurance 730, which in some embodiments can be financial institution 710, service information or other information indicating whether to proceed with the transaction, even if both parties are qualified. In step 732, if all responses indicate that the transaction should move forward, the transaction will transpire. In step 734, documentation of the transaction and the insurance service is provided to the customer.

In various other embodiments the multi-tiered transaction operation provides additional levels of security. Thus, insurance service 716 can be a government agency that reviews suspicious activity according to embodiments of the invention. An embodiment an embodiment of the present invention uses a virtual wallet to allow the government to track foreign nationals with suspicious and/or known volatile backgrounds and to prevent any individual and/or group of individuals from amassing arsenals without the government's knowledge. This invention would require not only U.S. citizens to register his/her print and UUID with a centralized law enforcement agency, but would also require all foreign nationals to register his/her prints and UUIDs upon entry into the country. The wireless transceiver biometric device 100 of the present invention can be used to replace printed documents, such as a driver's license, identification card, credit cards, pilot's licenses, passports, etc. In some embodiments, a cashless system can be employed. Through the wireless transceiver biometric device 100, money transfers, credit lines, etc., can be uploaded for purchases. Foreign nationals would be required to purchase a wireless transceiver biometric device 100 to upload money transfer, credit lines, etc, from the foreign national's place of origin. In some embodiments, authorizer verification, and identification, as described above, is also forwarded to government agencies when large monetary transactions occur, when purchases of restricted products (e.g., firearms, explosives, and other weaponry) occur and when travel that is deemed non-rapid (e.g., air travel, cruise ship travel, trains, etc.) occur.

In some embodiments, authorizer verification and identification of weaponry would provide a “cooling off” period for all purchases of weapons during which time a governing agency could review the request for purchase and investigate the purchaser. Also, this can prevent “under the table” transactions for weapons, flight training, etc., by eliminating cash transfer for transactions deemed “restricted” and allow visibility of these types of transactions to the government. Further, this can reduce or eliminate “black market” transactions such as arms and drugs within the borders of the country. E. Multi-Tiered Authorization Method

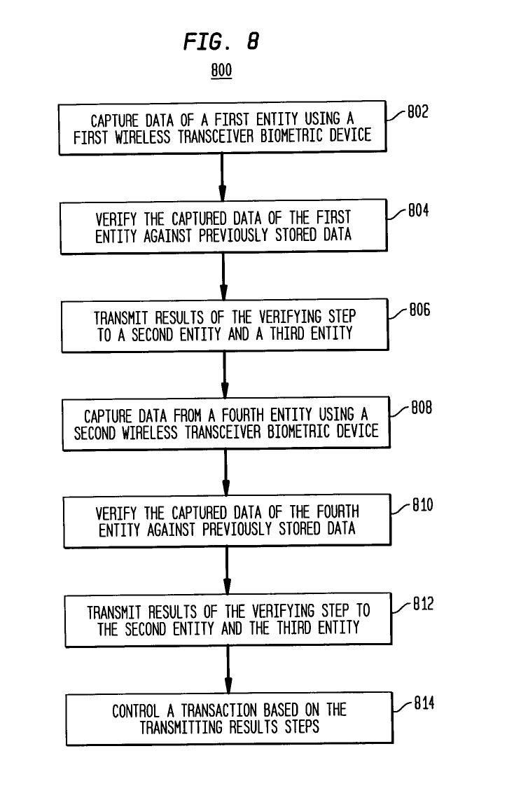

FIG. 8 is a flowchart depicting a method 800 according to embodiments of the present invention (steps 802-814). At step 802, data of a first entity is captured using a first wireless transceiver biometric device. At step 804, the captured data of the first entity is verified against previously stored data. At step 806, results of the verifying step are transmitted to a second entity and a third entity. At step 808, data from a fourth entity is captured using a second wireless transceiver biometric device. At step 810, the captured data of the fourth entity to is verified against previously stored data. At step 812, results of the verifying step is transmitted to the second entity and the third entity. At step 814, a transaction is controlled based on the transmitting results steps.

Compatibility Feature

As described above, embodiments of the invention are capable of interacting with other devices as part of a personal area network. The personal identification device of the invention can be implemented to communicate with other devices using any known wireless communications system or protocol, such as BLUETOOTH and/or IEEE 802.11.

### CONCLUSION

While various embodiments of the present invention have been described above, it should be understood that they have been presented by way of example only, and not limitation. It will be understood by those skilled in the art that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A method comprising the steps of:
capturing data of a first entity using a first wireless transceiver biometric device;
verifying said captured data of the first entity against previously stored data;
transmitting results of said verifying step to a second entity and a third entity;
capturing data from a fourth entity using a second wireless transceiver biometric device;
verifying said captured data of the fourth entity against previously stored data;
transmitting results of said verifying step to the second entity and the third entity; and
controlling a transaction based on said transmitting results steps.

2. The method of claim 1, wherein said capturing data of the first entity step captures comprises capturing print data.

3. The method of claim 1, wherein said capturing data of the first entity step comprises capturing UUID data.

4. The method of claim 1, wherein said capturing data of the first entity step comprises capturing UUID and print data.

5. The method of claim 1, wherein said capturing data of the first entity step comprises capturing biometric data.

6. The method of claim 1, wherein said capturing data of the first entity step comprises capturing financial data and biometric data.

7. The method of claim 1, wherein said verifying data of the first entity step comprises transmitting said captured data to a verification entity.

8. The method of claim 1, wherein said capturing data of the fourth entity step comprises capturing biometric data.

9. The method of claim 1, wherein said capturing data of the fourth entity step comprises capturing print data.

10. The method of claim 1, wherein said capturing data of the fourth entity step comprises capturing UUID data.

11. The method of claim 1, wherein said capturing data of the fourth entity step comprises capturing UUID and print data.

12. The method of claim 1, wherein said verifying data of the fourth entity step comprises transmitting said captured data to a verification entity.

13. The method of claim 1, wherein said transmitting results steps comprise transmitting a certificate of authentication via a network.

14. The method of claim 1, wherein:
the second entity is an insurance entity;
the third entity is a financial entity; and
the insurance entity insures said transaction step for the first party.

15. The method of claim 1, wherein:
the second entity is a governmental entity;
the third entity is a private entity; and
the governmental entity monitors the first entity and said transaction step.

16. The method of claim 15, wherein the private entity is a gun dealer.

17. The method of claim 1, wherein:
the second entity is a first governmental entity;
the third entity is a second government entity; and
the first governmental entity monitors the first entity and said transaction step.

18. The method of claim 17, wherein:
the first governmental entity is a law enforcement entity; and
the second governmental entity is an administrative entity.
